(19) United States
(12) Patent Application Publication
(10) Pub. No.: US 2026/0285322 A1
(43) Pub. Date: Sep. 24, 2026

(54) METHOD OF CONTROLLING OPERATION OF A VEHICLE, COMPUTER PROGRAM, COMPUTER-READABLE MEDIUM, CONTROL ARRANGEMENT, AND VEHICLE

(71) Applicant: Scania CV AB, Södertälje (SE)

(72) Inventors: Jonathan ADOLFSSON, Bandhagen (SE); Anders KJELL, Ekerö (SE); Christian WESSEL, Rönninge (SE); Tomas SELLING, Tyresö (SE)

(73) Assignee: Scania CV AB, Södertälje (SE)

(21) Appl. No.: 19/476,301

(22) PCT Filed: Apr. 17, 2024
(86) PCT No.: PCT/SE2024/050370

§ 371 Date: Oct. 17, 2025

(30) Foreign Application Priority Data
Apr. 24, 2023 (SE) 2350486-3

(51) Int. Cl. B60W 30/19; B60W 10/08; B60W 10/11; B60W 20/15

(52) U.S. Cl. CPC B60W 30/19; B60W 10/08; B60W 10/11; B60W 20/15; B60W 2300/12; B60W 2720/30

(57) ABSTRACT

A method of controlling operation of a vehicle is disclosed, wherein the vehicle comprises two or more powertrains each comprising a power source configured to provide motive power to the vehicle via wheels arranged at a respective wheel axle. The method comprises performing a gear shift in a transmission of one of the two or more powertrains, and controlling the power source of at least one other powertrain of the two or more powertrains to compensate for at least part of an interruption of a wheel torque obtained during the step of performing the gear shift. The present disclosure further relates to a computer program, a computer-readable medium, a control arrangement, and a vehicle.

### TECHNICAL FIELD

The present disclosure relates to a method of controlling operation of a vehicle, wherein the vehicle comprises two or more powertrains each comprising a power source configured to provide motive power to the vehicle via wheels arranged at a respective wheel axle of the vehicle. The present disclosure further relates to a computer program, a computer-readable medium, a control arrangement, and a vehicle.

### BACKGROUND

Wheeled vehicles such as passenger cars, trucks, busses, and the like, normally comprise two or more wheel axles and a number of wheels arranged at each of the two or more wheel axles. Moreover, vehicles commonly comprise wheel brakes controllable to brake the wheels arranged at each of the two or more wheel axles of the vehicle. The wheel brakes may comprise drum brakes, disc brakes, or the like.

Powertrains are used in vehicles for providing motive power to the vehicle via a number of wheels of the vehicle. A powertrain comprises a power source and a drive train. The power source may for example comprise an internal combustion engine, an electric machine, or the like. The drivetrain can be said to comprise all components that transfer power between the power source and wheels of the vehicle, such as a transmission, driveshafts, differentials, axles, and the like.

Traditionally, vehicles have been equipped with one powertrain configured to provide motive power to the vehicle via wheels arranged at one or more wheel axles of the vehicle. Wheels that are, or at least can be, operably connected to a power source of the vehicle are normally referred to as driven wheels, whereas wheels that are not, nor can be, operably connected to the power source of the vehicle are normally referred to as non-driven wheels. A wheel axle comprising driven wheels arranged at two opposite lateral sides of the wheel axle is usually referred to as a driven axle.

Moreover, traditionally, vehicles have been powered using an internal combustion engine.

However, the use of electric drive for vehicles provides many advantages, especially regarding local emissions. Such vehicles comprise one or more electric propulsion motors configured to provide motive power to the vehicle. These types of vehicles can be divided into the categories pure electric vehicles and hybrid electric vehicles. Pure electric vehicles, sometimes referred to as battery electric vehicles, only-electric vehicles, and all-electric vehicles, comprise a pure electric powertrain and comprise no internal combustion engine and therefore produce no emissions in the place where they are used.

A hybrid electric vehicle comprises two or more distinct types of power, such as an internal combustion engine and an electric propulsion system. The combination of an internal combustion engine and an electric propulsion system provides advantages with regard to energy efficiency, partly because of the poor energy efficiency of an internal combustion engine at lower power output levels. Moreover, some hybrid electric vehicles are capable of operating in pure electric drive when wanted, such as when driving in certain areas.

In at least partially electric vehicles, such as in pure electric vehicles and hybrid electric vehicles, the electricity is usually stored in a number of battery packs each comprising a number of rechargeable battery cells. Some different types of battery cells are used, such as lithium-ion battery cells, lithium polymer battery cells, as well as other types of rechargeable battery cells.

As mentioned, traditionally, vehicles have been equipped with one powertrain configured to provide motive power to the vehicle via wheels arranged at one or more wheel axles of the vehicle. However, recent development, including the current trend of electrification, has led to the vehicles comprising two or more powertrains each comprising a power source configured to provide motive power to the vehicle via wheels arranged at a respective wheel axle of the vehicle.

Many vehicle transmissions comprise a gearbox controllable between different gears to provide different gear ratios between an output shaft of the power source and wheels of the vehicle. In this manner, a high operational efficiency can be obtained of a powertrain at various vehicle speeds. Moreover, appropriate propulsion force and/or repulsion force can be obtained in various situations by shifting gears in the gearbox.

In most cases, the transfer of power through a gearbox has to be interrupted during gear shifts so as to enable the gear shift and avoid damage to components of the gearbox. That is, if the transfer of power through the gearbox is not interrupted, the torque between gears of the gearbox may prevent gearbox manoeuvring parts of the gearbox from performing a gear shift. In many cases, the transfer of power through a gearbox is interrupted by controlling a clutch arranged between the power source and the gearbox.

The interruption of transfer of power through the gearbox causes an interruption of wheel torque during gear shifts. The interruption of wheel torque impairs the operational performance of the vehicle and may have a negative impact on the comfort for occupants in the vehicle.

Gearshifts can be performed during an acceleration phase of the vehicle in a forward moving direction thereof as well as during retardation phases of the vehicle. Therefore, the above-mentioned interruption of wheel torque can impair the operational performance of the vehicle and may have a negative impact on the comfort for occupants of the vehicle, during acceleration phases as well as during retardation phases of the vehicle.

One solution for mitigating the impact of torque interruption during gearshifts is to perform gearshifts quickly to thereby minimize the time needed for the gearshift and consequently also the duration of the torque interruption. However, too quick gearshifts may cause excessive wear and tear of components of the gearbox which over time may damage the gearbox.

A dual-clutch transmission, usually abbreviated DCT, is solution for reducing the interruption of wheel torque during gearchanges that is commonly found in high-performance sports cars and some modern passenger vehicles. A dual-clutch transmission is an advanced type of automated manual transmission that uses two separate clutches to reduce interruption of wheel torque during gearshifts. The dual-clutch transmission operates by using one clutch for odd-numbered gears and the other clutch for even-numbered gears. This allows for quick and smooth gear changes.

However, dual-clutch transmissions can be more complex and expensive to manufacture and maintain compared to traditional transmissions, and in general, it is an advantage if products, such as vehicles and associated components, systems, and arrangements, have conditions and/or characteristics suitable for being manufactured and assembled in a cost-efficient manner.

### SUMMARY

It is an object of the present invention to overcome, or at least alleviate, at least some of the above-mentioned problems and drawbacks.

According to a first aspect of the invention, the object is achieved by a method of controlling operation of a vehicle, wherein the method is performed by a control arrangement, and
wherein the vehicle comprises two or more powertrains each comprising a power source configured to provide motive power to the vehicle via wheels arranged at a respective wheel axle of the vehicle,
wherein each of the two or more powertrains is separate from, and independent of, the other of the two or more powertrains,
and wherein the method comprises:
   performing a gear shift in a transmission of one of the two or more powertrains, and
   controlling the power source of at least one other powertrain of the two or more powertrains to compensate for at least part of an interruption of a wheel torque obtained during the step of performing the gear shift.

Thereby, a method is provided capable of alleviating the effects of the interruption of the wheel torque obtained during the gear shift without significantly adding costs and complexity to the vehicle. That is, due to the features of the method, the total propulsion force or retardation force can be at least substantially maintained during the step of performing the gear shift. Accordingly, in this manner, a smooth and comfortable operation of the vehicle can be provided without significantly adding costs and complexity to the vehicle. In addition, the operational performance of the vehicle can be at least substantially maintained during gear shifts without significantly adding costs and complexity to the vehicle.

Accordingly, a method is provided overcoming, or at least alleviating, at least some of the above-mentioned problems and drawbacks. As a result, the above-mentioned object is achieved.

The step of performing the gear shift may comprise a control of gearbox manoeuvring parts of the transmission. The step of controlling the power source may comprise a control of a power output of the power source.

Optionally, the step of controlling the power source comprises:
controlling the power source to increase a positive wheel torque if an interruption of a positive wheel torque is obtained during the step of performing the gear shift.

Thereby, a total propulsion force can be at least substantially maintained during the step of performing the gear shift. Accordingly, in this manner, a smooth and comfortable acceleration of the vehicle can be provided without significantly adding costs and complexity to the vehicle. In addition, the acceleration performance of the vehicle can be at least substantially maintained during gear shifts without significantly adding costs and complexity to the vehicle.

Optionally, the step of controlling the power source comprises:
controlling the power source to increase a negative wheel torque if an interruption of a negative wheel torque is obtained during the step of performing the gear shift.

Thereby, a total retardation force can be at least substantially maintained during the step of performing the gear shift. Accordingly, in this manner, a smooth and comfortable retardation of the vehicle can be provided without significantly adding costs and complexity to the vehicle. In addition, the retardation performance of the vehicle can be at least substantially maintained during gear shifts without significantly adding costs and complexity to the vehicle.

Optionally, the method comprises the step of:
blocking gear shifts from being performed in a transmission of at least one other powertrain of the two or more powertrains during the step of performing the gear shift.

Thereby, simultaneous gear shifts in two or more transmissions of the vehicle are avoided.

As a result, a smooth, even, and comfortable operation of the vehicle can be ensured without significantly adding costs and complexity to the vehicle. In addition, a more even operational performance of the vehicle can be ensured without significantly adding costs and complexity to the vehicle.

According to a second aspect of the invention, the object is achieved by a computer program comprising instructions which, when the program is executed by a computer, cause the computer to carry out the method according to some embodiments of the present disclosure. Since the computer program comprises instructions which, when the program is executed by a computer, cause the computer to carry out the method according to some embodiments described herein, a computer program is provided which provides conditions for overcoming, or at least alleviating, at least some of the above-mentioned drawbacks. As a result, the above-mentioned object is achieved.

According to a third aspect of the invention, the object is achieved by a computer-readable medium comprising instructions which, when executed by a computer, cause the computer to carry out the method according to some embodiments of the present disclosure. Since the computer-readable medium comprises instructions which, when the program is executed by a computer, cause the computer to carry out the method according to some embodiments described herein, a computer-readable medium is provided which provides conditions for overcoming, or at least alleviating, at least some of the above-mentioned drawbacks. As a result, the above-mentioned object is achieved.

According to a fourth aspect of the invention, the object is achieved by a control arrangement configured to control operation of a vehicle, wherein the vehicle comprises two or more powertrains each comprising a power source configured to provide motive power to the vehicle via wheels arranged at a respective wheel axle of the vehicle,
wherein each of the two or more powertrains is separate from, and independent of, the other of the two or more powertrains,
and wherein the control arrangement is configured to:
   perform a gear shift in a transmission of one of the two or more powertrains, and
   control the power source of at least one other powertrain of the two or more powertrains to compensate for at least part of an interruption of a wheel torque obtained during the gear shift.

Thereby, a control arrangement is provided capable of alleviating the effects of the interruption of the wheel torque obtained during the gear shift without significantly adding costs and complexity to the vehicle. That is, due to the control performed by the control arrangement, the total propulsion force or retardation force can be at least substantially maintained when performing gear shifts. Accordingly, in this manner, a smooth and comfortable operation of the vehicle can be provided without significantly adding costs and complexity to the vehicle. In addition, the operational performance of the vehicle can be at least substantially maintained during gear shifts without significantly adding costs and complexity to the vehicle.

Accordingly, a control arrangement is provided overcoming, or at least alleviating, at least some of the above-mentioned problems and drawbacks. As a result, the above-mentioned object is achieved.

It will be appreciated that the various embodiments described for the method are all combinable with the control arrangement as described herein. That is, the control arrangement according to the fourth aspect of the invention may be configured to perform any one of the method steps of the method according to the first aspect of the invention.

According to a fifth aspect of the invention, the object is achieved by a vehicle comprising two or more powertrains each comprising a power source configured to provide motive power to the vehicle via wheels arranged at a respective wheel axle of the vehicle,
wherein each of the two or more powertrains is separate from, and independent of, the other of the two or more powertrains,
and wherein the vehicle comprises a control arrangement configured to:
   perform a gear shift in a transmission of one of the two or more powertrains, and
   control the power source of at least one other powertrain of the two or more powertrains to compensate for at least part of an interruption of a wheel torque obtained during the gear shift.

Thereby, a vehicle is provided capable of at least substantially maintaining a total propulsion force or retardation force when performing gear shifts. Accordingly, in this manner, a smooth and comfortable operation of the vehicle can be ensured without significantly adding costs and complexity to the vehicle. In addition, the operational performance of the vehicle can be at least substantially maintained during gear shifts without significantly adding costs and complexity to the vehicle.

Accordingly, a vehicle is provided overcoming, or at least alleviating, at least some of the above-mentioned problems and drawbacks. As a result, the above-mentioned object is achieved.

Optionally, the power source of at least one of the two or more powertrains is an electric machine. Thereby, conditions are provided for an environmentally friendly vehicle. Moreover, conditions are provided for an accurate control of the at least one power source.

Optionally, the vehicle is a heavy road vehicle, such as a truck or a bus. Thereby, a heavy road vehicle is provided having at least some of the above-mentioned advantages.

Further features of, and advantages with, the present invention will become apparent when studying the appended claims and the following detailed description.

### BRIEF DESCRIPTION OF THE DRAWINGS

Various aspects of the invention, including its particular features and advantages, will be readily understood from the example embodiments discussed in the following detailed description and the accompanying drawings, in which:

FIG. 1 schematically illustrates a vehicle according to some embodiments,

FIG. 2 schematically illustrates wheel axles, powertrains, and a wheel brake system of the vehicle illustrated in FIG. 1,

FIG. 3 schematically illustrates a method of controlling operation of a vehicle, and

FIG. 4 illustrates a computer-readable medium.

### DETAILED DESCRIPTION

Aspects of the present invention will now be described more fully. Like reference signs refer to like elements throughout. Well-known functions or constructions will not necessarily be described in detail for brevity and/or clarity.

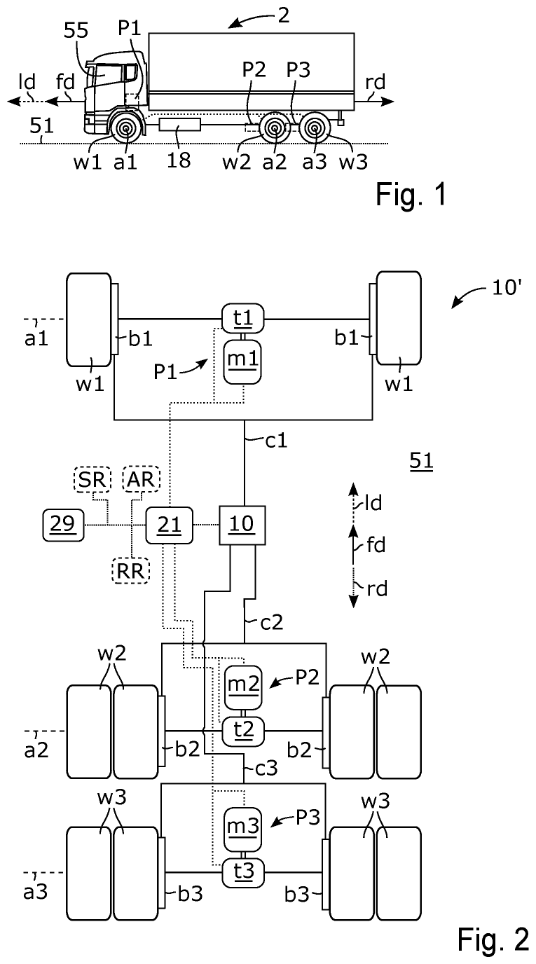

FIG. 1 schematically illustrates a vehicle 2 according to some embodiments. According to the illustrated embodiments, the vehicle 2 is a truck, i.e., a type of heavy road vehicle as well as a type of heavy commercial vehicle. According to further embodiments, the vehicle 2, as referred to herein, may be another type of heavy or lighter type of manned or unmanned vehicle for land-based propulsion such as a lorry, a bus, a construction vehicle, a tractor, a car, or the like.

In FIG. 1, the vehicle 2 is illustrated as comprising three wheel axles a1, a2, a3. In some places below, the wheel axles a1, a2, a3 of the vehicle 2 are referred to as a first wheel axle a1, a second wheel axle a2, and a third wheel axle a3. According to further embodiments, the vehicle 2 may comprise another number of wheel axles a1, a2, a3, such as two wheel axles only or more than three wheel axles. As is further explained herein, each wheel axle a1, a2, a3 of the vehicle 2 comprises a number of wheels w1, w2, w3 arranged at the wheel axle a1, a2, a3. That is, each of the wheel axle a1, a2, a3 of the vehicle 2 supports a number of wheels w1, w2, w3 relative to a chassis of the vehicle 2. In FIG. 1, the chassis of the vehicle 2 has not been provided with a reference sign for reasons of brevity and clarity. The number of wheels w1, w2, w3 of the vehicle 2 may also be referred to as a number of ground engaging wheels w1, w2, w3 of the vehicle 2.

According to the illustrated embodiments, the vehicle 2 comprises two wheels w1 arranged at the first wheel axle a1 and four wheels w2, w3 arranged at each of the second wheel axle a2 and the third wheel axle a3. However, according to further embodiments, the vehicle 2 may comprise another number of wheels w1, w2, w3 arranged at the wheel axles a1, a2, a3 thereof, such as two or more wheels w1, w2, w3 arranged at each wheel axle a1, a2, a3 of the vehicle 2.

According to the illustrated embodiments, the first wheel axle a1 constitutes a front wheel axle and the wheels w1 thereof thus constitute front wheels of the vehicle 2. Moreover, according to the illustrated embodiments, each of the second and third wheel axle a2, a3 can be said to constitute a rear wheel axle and the wheels w2, w3 thereof can be said to constitute rear wheels of the vehicle 2. According to the embodiments illustrated in FIG. 1, the second and third wheel axles a2, a3 are arranged relatively close to each other and can be said to together form a tandem axle of the vehicle 2.

Moreover, according to the illustrated embodiments, the wheels w1 of the first wheel axle a1 are steered driven wheels whereas the wheels w2, w3 of the second and third wheel axle a2, a3 are non-steered driven wheels. The feature that the wheels w1 of the first wheel axle a1 are steered wheels means that the vehicle 2 comprises a steering system controllable to change a rolling direction of the number of wheels w1 relative to the chassis of the vehicle 2. However, according to further embodiments, the vehicle 2 may comprise another configuration of wheels w1, w2, w3 and wheel axles a1, a2, a3 than depicted in FIG. 1.

In FIG. 1, the vehicle 2 is illustrated as positioned in an intended use position on a surface 51 supporting the vehicle 2. As seen in FIG. 1, the number of wheels w1, w2, w3 of the vehicle 2 is configured to abut against the surface 51 when the vehicle 2 is positioned in the intended use position thereon. Moreover, in FIG. 1, a forward moving direction fd and a reverse moving direction rd are indicated. The reverse moving direction rd of the vehicle 2 is opposite to the forward moving direction fd of the vehicle 2. Furthermore, in FIG. 1, a longitudinal direction Id of the vehicle 2 is indicated. The longitudinal direction Id of the vehicle 2 is parallel to each of the forward moving direction fd and the reverse moving direction rd of the vehicle 2.

According to the embodiments illustrated in FIG. 1, the vehicle 2 comprises three powertrains P1, P2, P3. In some places below, these are referred to as a first powertrain P1, a second powertrain P2, and a third powertrain P3. According to the illustrated embodiments, the first powertrain P1 is controllable to provide motive power to the vehicle 2 via the wheels w1 arranged at the first wheel axle a1, the second powertrain P2 is controllable to provide motive power to the vehicle 2 via the wheels w2 arranged at the second wheel axle a2, and the third powertrain P1 is controllable to provide motive power to the vehicle 2 via the wheels w3 arranged at the third wheel axle a3.

FIG. 2 schematically illustrates the wheel axles a1, a2, a3, the powertrains P1, P2, P3, and a wheel brake system 10′ of the vehicle 2 illustrated in FIG. 1. In FIG. 2, the components and systems are illustrated as viewed in a direction straight towards the surface 51 illustrated in FIG. 1, i.e., straight towards the surface 51 supporting the vehicle 2 in FIG. 1. Below, simultaneous reference is made to FIG. 1 and FIG. 2, if not indicated otherwise.

According to the illustrated embodiments, each powertrain P1, P2, P3 comprises a power source m1, m2, m3 configured to provide motive power to the vehicle 2 via the wheels w1, w2, w3 arranged at a respective wheel axle a1, a2, a3. Moreover, according to the illustrated embodiments, each of the powertrains P1, P2, P3 comprises a transmission t1, t2, t3 configured to transmit power between the power source m1, m2, m3 and the wheels w1, w2, w3 arranged at a respective wheel axle a1, a2, a3.

That is, in more detail, according to the illustrated embodiments, the first powertrain P1 comprises a first power source m1 configured to provide motive power to the vehicle 2 via the first transmission t1 and the wheels w1 arranged at the first wheel axle a1, the second powertrain P2 comprises a second power source m2 configured to provide motive power to the vehicle 2 via the second transmission t2 and the wheels w2 arranged at the second wheel axle a2, and the third powertrain P3 comprises a third power source m3 configured to provide motive power to the vehicle 2 via the third transmission t3 and the wheels w3 arranged at the third wheel axle a3. Each transmission t1, t2, t3 may comprise a number of torque transmission arrangements, including one or more of a driveshaft, a differential, an axle, a gearbox, a gear, and the like.

According to the illustrated embodiments, the power source m1, m2, m3 of each of the powertrains P1, P2, P3 of the vehicle 2 is an electric machine. That is, each of the first, second, and third power source m1, m2, m3 referred to above is an electric machine. The power source m1, m2, m3 of the powertrains P1, P2, P3 of the vehicle 2 are configured to operate using electricity from a propulsion battery 18 indicated in FIG. 1. The propulsion battery 18 may comprise a number of rechargeable battery cells, such as lithium-ion battery cells, lithium polymer battery cells, or the like. According to the embodiments illustrated in FIG. 1, the vehicle 2 is a pure electric vehicle and comprises no internal combustion engine for providing motive power to the vehicle 2.

According to the illustrated embodiments, each transmission t1, t2, t3 is controllable between at least two different gear steps to provide at least two different gear ratios between an output shaft of a respective power source m1, m2, m3 and wheels w1, w2, w3 at a respective wheel axle a1, a2, a3. According to further embodiments, at least one transmission t1, t2, t3 of the powertrains P1, P2, P3 of the vehicle 2 is controllable between at least two different gear steps to provide at least two different gear ratios between an output shaft of a power source m1, m2, m3 and wheels w1, w2, w3 at a wheel axle a1, a2, a3 of the vehicle 2. A transmission t1, t2, t3, as referred to herein, may be represented by a gearbox.

As mentioned, according to the embodiments illustrated in FIG. 2, each of the powertrains P1, P2, P3 comprises a transmission t1, t2, t3 configured to transmit power between the power source m1, m2, m3 and the wheels w1, w2, w3 arranged at a respective wheel axle a1, a2, a3. However, according to some embodiments, one or more of the powertrains P1, P2, P3 of the vehicle 2 may comprise a pair of wheel motors each operably connected to one or more wheels w1, w2, w3 at a respective lateral side of the vehicle 2. Such a wheel motor may be operably connected to one or more wheels w1, w2, w3 at a wheel axle a1, a2, a3 via a transmission arranged in the vicinity of the one or more wheels w1, w2, w3 at the wheel axle a1, a2, a3. Moreover, the wheel motor and the transmission may be integrated a wheel hub of the vehicle 2. The transmission may for example comprise a driveshaft, a gear pair, epicyclic gearing, and an output shaft connected to the one or more wheels w1, w2, w3 at a wheel axle a1, a2, a3, or the like.

According to some embodiments, at least one of the two or more powertrains P1, P2, P3 comprises a power source m1, m2, m3 in the form of an electric machine. Moreover, according to some embodiments, one or more of the powertrains P1, P2, P3 of the vehicle 2 may comprise an internal combustion engine configured to provide motive power to the vehicle 2. Furthermore, one or more of the powertrains P1, P2, P3 of the vehicle 2 may comprise the combination of an internal combustion engine and an electric machine. Thus, according to some embodiments, the vehicle 2 as referred to herein may be a so-called hybrid electric vehicle 2.

Furthermore, according to some embodiments, one or more of the power sources m1, m2, m3 of the vehicle 2 may comprise a retarder configured to provide braking power to the vehicle 2 via the wheels w1, w2, w3 arranged at a respective wheel axle a1, a2, a3 upon activation. Such a retarder may be of electric and/or hydraulic type.

According to the illustrated embodiments, each powertrain P1, P2, P3 of the vehicle 2 is separate from, and independent of, the other of the powertrains P1, P2, P3 of the vehicle 2. The feature that each powertrain P1, P2, P3 of the vehicle 2 is separate from the other of the powertrains P1, P2, P3 of the vehicle 2 means that the powertrains P1, P2, P3 are structurally separated and form distinct separate arrangements. The feature that each powertrain P1, P2, P3 of the vehicle 2 is independent of the other of the powertrains P1, P2, P3 of the vehicle 2 means that each powertrain P1, P2, P3 can be controlled independently of the other powertrains P1, P2, P3, i.e., can be controlled such that a control action changing the power output of a powertrain P1, P2, P3 does not need to result is a change in the power output of one or more of the other powertrains P1, P2, P3 of the vehicle 2.

As mentioned above, the vehicle 2 comprises a wheel brake system 10′. The wheel brake system 10′ comprises wheel brakes b1, b2, b3 arranged at wheels w1, w2, w3 of each wheel axle a1, a2, a3 of the vehicle 2. The wheel brakes b1, b2, b3 are controllable to brake the wheels w1, w2, w3 arranged at each wheel axle a1, a2, a3 of the vehicle 2. The wheel brakes b1, b2, b3 may comprise friction brake arrangements, such as drum brakes, disc brakes, or a combination thereof. Drum brakes normally comprise a cylinder-shaped part called a brake drum and a set of shoes or pads controllable to be pressed against the cylinder-shaped part to create friction therebetween for braking the wheels w1, w2, w3. Disc brakes normally comprise a disc and a set of pads controllable to be pressed against the disc to create friction therebetween for braking the wheels w1, w2, w3.

The wheel brake system 10′ further comprises a brake control unit 10 and a number of conduits c1, c2, c3 between the brake control unit 10 and the wheel brakes b1, b2, b3 arranged at the wheels w1, w2, w3 at the respective wheel axles a1, a2, a3. In FIG. 2, the wheel brake system 10′ is illustrated in simplified form. However, the wheel brake system 10′ may be configured to perform an individual control of the application of the wheel brakes b1, b2, b3 at the respective wheels w1, w2, w3.

Moreover, in FIG. 2, the forward moving direction fd, the reverse moving direction rd, and the longitudinal direction Id of the vehicle 2 are indicated. As understood from above, and as is indicated in FIG. 2, the wheel axles a1, a2, a3 of the vehicle 2 are arranged at a distance from each other as seen along the longitudinal direction Id of the vehicle 2. In other words, the wheel axles a1, a2, a3 of the vehicle 2 are arranged at different longitudinal positions on the vehicle 2, i.e., at different positions along the longitudinal direction Id of the vehicle 2.

As seen in FIG. 2, according to the illustrated embodiments, the distance between the second and third wheel axles a2, a3 is considerably smaller than the distance between the first and second wheel axles a1, a2. In other words, the second and third wheel axles a2, a3 are arranged relatively close to each other as seen along the longitudinal direction Id of the vehicle 2, and as indicated in FIG. 2, according to the illustrated embodiments, the second and third wheel axles a2, a3 together form one tandem axle of the vehicle 2. Moreover, as understood from the above, according to the illustrated embodiments, each of the second and third wheel axles a2, a3 is a driven axle. Moreover, the wheels w2, w3 of these wheel axles a2, a3 are driven by a powertrain P2, P3 being separate from, and independent of, the powertrain P2, P3 of the other wheel axle a2, a3.

Furthermore, as is understood from the above, according to the illustrated embodiments, the first wheel axle a1 is also a driven wheel axle, wherein the wheels w1 of the first wheel axle a1 are driven by a powertrain P1 being separate from, and independent of, the powertrains P2, P3 of the second and third wheel axles a2, a3.

However, according to further embodiments, the vehicle 2 may comprise another configuration of driven and non-driven wheel axles a1, a2, a3. As understood from the above, according to embodiments herein, the vehicle 2 comprises two or more powertrains P1, P2, P3 each comprising a power source m1, m2, m3 configured to provide motive power to the vehicle 2 via wheels w1, w2, w3 arranged at a respective wheel axle a1, a2, a3 of the vehicle 2, wherein each of the two or more powertrains P1, P2, P3 is separate from, and independent of, the other of the two or more powertrains P1, P2, P3.

As is indicated in FIG. 2, the vehicle 2 comprises a control arrangement 21. According to the illustrated embodiments, the control arrangement 21 is operably connected to each power source m1, m2, m3 and each transmission t1, t2, t3 of the powertrains P1, P2, P3 of the vehicle 2.

According to embodiments herein, the control arrangement 21 is configured to perform a gear shift in a transmission t1, t2, t3 of one of the two or more powertrains P1, P2, P3, and control the power source m1, m2, m3 of at least one other powertrain P1, P2, P3 of the two or more powertrains P1, P2, P3 to compensate for at least part of an interruption of a wheel torque obtained during the gear shift.

In this manner, the effects of the interruption of the wheel torque obtained during the gear shift can be alleviated without significantly adding costs and complexity to the vehicle 2. That is, due to the control performed by the control arrangement 21, the total propulsion force or retardation force can be at least substantially maintained when performing gear shifts.

Accordingly, in this manner, a smooth and comfortable operation of the vehicle 2 can be provided and the operational performance of the vehicle 2 can be at least substantially maintained during gear shifts without significantly adding costs and complexity to the vehicle 2.

According to some embodiments, the control arrangement 21 is configured to input a gear shift request SR from an input device arranged in a driver environment 55 of the vehicle 2 or from a control device 29 of the vehicle 2 and may be configured to perform a gear shift in a transmission t1, t2, t3 of one of the two or more powertrains P1, P2, P3 upon receipt of a gear shift request SR. The control arrangement 21 may be configured to perform a gear shift of a transmission t1, t2, t3 by controlling gear shift manoeuvring parts of the transmission t1, t2, t3. The gear shift manoeuvring parts may comprise one or more actuators controllable by the control arrangement 21.

The input device arranged in the driver environment 55 of the vehicle 2 may for example comprise a gear shift lever, a button, a switch, a knob, or the like. The control device 29, and/or the control arrangement 21, may form part of an autonomous driving system of the vehicle 2. The autonomous driving system may be capable of operating the vehicle 2 in an at least partially autonomous manner based on input from a number of sensor devices, i.e., at least in part in a manner not requiring the direct intervention of a human. According to some embodiments, the autonomous driving system may be configured to drive, i.e., steer, brake, and/or propel, the vehicle 2 based on input from a number of sensor devices in a manner not requiring the direct intervention of a human. The number of sensor devices may comprise one or more of a Radio Detection and Ranging (radar) sensor, a Light Detection and Ranging (lidar) sensor, an image capturing unit, such as a camera, an ultrasound sensor, or the like.

Moreover, the control device 29, and/or the control arrangement 21, may be configured to generate gear shift requests SR based on data representative of one or more of a current speed of the vehicle 2, current operational speeds of one or more power sources m1, m2, m3 of the vehicle 2, the magnitude of an acceleration request AR, the magnitude of a retardation request RR, and the like. In FIG. 2, a gear shift request SR, an acceleration request AR, and a retardation request RR is schematically indicated inside a respective dashed box.

An acceleration request AR may be inputted from an input device arranged in the driver environment 55 of the vehicle 2, such as from an accelerator pedal assembly arranged in the driver environment 55 of the vehicle 2 and/or from a control device, such as a control device 29 referred to above. Likewise, a retardation request RR may be inputted from an input device arranged in the driver environment 55 of the vehicle 2, such as from a brake pedal assembly arranged in the driver environment 55 of the vehicle 2, and/or from a control device, such as a control device 29 referred to above.

According to some embodiments, the control arrangement 21 is configured to control the power source m1, m2, m3 to increase a positive wheel torque if an interruption of a positive wheel torque is obtained during the gear shift. That is, according to these embodiments, the control arrangement 21 may be configured to control the power source m1, m2, m3 of one or more powertrains P1, P2, P3 to increase a positive wheel torque of wheels w1, w2, w3 powered by the power source m1, m2, m3 if a gear shift in the transmission t1, t2, t3 of another powertrain P1, P2, P3 causes an interruption of a positive wheel torque.

As an example, if the vehicle 2 currently is travelling on a flat road surface and is accelerating in a forward moving direction fd of the vehicle 2 following the receipt of an acceleration request AR, a gear shift in one of the transmissions t1, t2, t3 may result in an interruption of a positive wheel torque. By controlling the power source m1, m2, m3 of one or more other powertrains P1, P2, P3 to increase a positive wheel torque during the gear shift to compensate for at least part of the interruption, a smooth and comfortable acceleration of the vehicle 2 can be provided without significantly adding costs and complexity to the vehicle 2. In addition, the acceleration performance of the vehicle 2 can be at least substantially maintained during the gear shift without significantly adding costs and complexity to the vehicle.

According to some embodiments, the control arrangement 21 is configured to control the power source m1, m2, m3 to increase a negative wheel torque if an interruption of a negative wheel torque is obtained during the gear shift. That is, according to such embodiments, the control arrangement 21 may be configured to control the power source m1, m2, m3 of one or more powertrains P1, P2, P3 to increase a negative wheel torque of wheels w1, w2, w3 powered by the power source m1, m2, m3 if a gear shift in the transmission t1, t2, t3 of another powertrain P1, P2, P3 causes an interruption of a negative wheel torque.

As an example, if the vehicle 2 currently is travelling on a flat road surface and is retarding in a forward moving direction fd of the vehicle 2 following the receipt of a retardation request RR, a gear shift in one of the transmissions t1, t2, t3 may result in an interruption of a negative wheel torque. By controlling the power source m1, m2, m3 of one or more other powertrains P1, P2, P3 to increase a negative wheel torque during the gear shift to compensate for at least part of the interruption, a smooth and comfortable retardation of the vehicle 2 can be provided without significantly adding costs and complexity to the vehicle 2. In addition, the retardation performance of the vehicle 2 can be at least substantially maintained during the gear shift without significantly adding costs and complexity to the vehicle.

As used herein, the term “positive wheel torque” means a wheel torque causing a force onto the vehicle 2 in the forward moving direction fd of the vehicle 2. Likewise, the term “negative wheel torque” means a wheel torque causing a force onto the vehicle 2 in the reverse moving direction rd of the vehicle 2.

According to some embodiments, the control arrangement 21 is configured to block gear shifts from being performed in a transmission t1, t2, t3 of at least one other powertrain P1, P2, P3 of the two or more powertrains P1, P2, P3 during the gear shift. That is, according to these embodiments, the control arrangement 21 may be configured to block gear shifts from being performed in one or more other transmissions t1, t2, t3 of the vehicle 2 during a gear shift in one of the transmissions t1, t2, t3. In this manner, simultaneous gear shifts in two or more transmissions t1, t2, t3 of the vehicle 2 are avoided. As a result, a smooth, even, and comfortable operation of the vehicle 2 can be ensured without significantly adding costs and complexity to the vehicle. In addition, a more even operational performance of the vehicle 2 can be ensured without significantly adding costs and complexity to the vehicle 2.

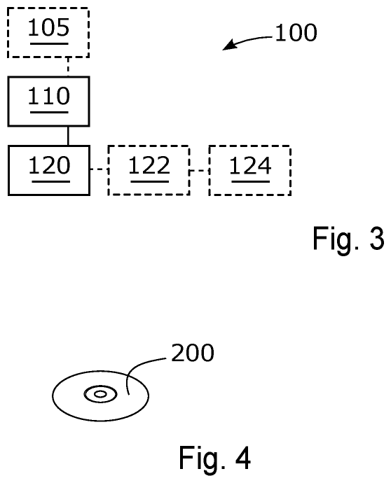

FIG. 3 schematically illustrates a method 100 of controlling operation of a vehicle. The vehicle may be a vehicle 2 as explained with reference to FIG. 1 and FIG. 2. Therefore, below, simultaneous reference is made to FIG. 1-FIG. 3, if not indicated otherwise.

The method 100 is performed by a control arrangement 21, and wherein the vehicle 2 comprises two or more powertrains P1, P2, P3 each comprising a power source m1, m2, m3 configured to provide motive power to the vehicle 2 via wheels w1, w2, w3 arranged at a respective wheel axle a1, a2, a3 of the vehicle 2, wherein each of the two or more powertrains P1, P2, P3 is separate from, and independent of, the other of the two or more powertrains P1, P2, P3, and wherein the method 100 comprises:
performing 110 a gear shift in a transmission t1, t2, t3 of one of the two or more powertrains P1, P2, P3, and
controlling 120 the power source m1, m2, m3 of at least one other powertrain P1, P2, P3 of the two or more powertrains P1, P2, P3 to compensate for at least part of an interruption of a wheel torque obtained during the step of performing 110 the gear shift.

As is indicated in FIG. 3, the step of controlling 120 the power source m1, m2, m3 may comprise:
controlling 122 the power source m1, m2, m3 to increase a positive wheel torque if an interruption of a positive wheel torque is obtained during the step of performing 110 the gear shift.

As is indicated in FIG. 3, the step of controlling 120 the power source m1, m2, m3 may comprise:
controlling 124 the power source m1, m2, m3 to increase a negative wheel torque if an interruption of a negative wheel torque is obtained during the step of performing 110 the gear shift.

Furthermore, as is indicated in FIG. 3, the method 100 may comprise the step of:
blocking 105 gear shifts from being performed in a transmission t1, t2, t3 of at least one other powertrain P1, P2, P3 of the two or more powertrains P1, P2, P3 during the step of performing 110 the gear shift.

It will be appreciated that the various embodiments described for the method 100 are all combinable with the control arrangement 21 as described herein. That is, the control arrangement 21 may be configured to perform any one of the method steps 105, 110, 120, 122, and 124 of the method 100.

FIG. 4 illustrates a computer-readable medium 200 comprising instructions which, when executed by a computer, cause the computer to carry out the method 100 according to some embodiments of the present disclosure. According to some embodiments, the computer-readable medium 200 comprises a computer program comprising instructions which, when the program is executed by a computer, cause the computer to carry out the method 100 according to some embodiments.

One skilled in the art will appreciate that the method 100 of controlling operation of a vehicle 2 may be implemented by programmed instructions. These programmed instructions are typically constituted by a computer program, which, when it is executed in the control arrangement 21, ensures that the control arrangement 21 carries out the desired control, such as the method steps 105, 110, 120, 122, and 124. The computer program is usually part of a computer program product 200 which comprises a suitable digital storage medium on which the computer program is stored.

The control arrangement 21 may comprise a calculation unit which may take the form of substantially any suitable type of processor circuit or microcomputer, e.g., a circuit for digital signal processing (digital signal processor, DSP), a Central Processing Unit (CPU), a processing unit, a processing circuit, a processor, an Application Specific Integrated Circuit (ASIC), a microprocessor, or other processing logic that may interpret and execute instructions. The herein utilised expression “calculation unit” may represent a processing circuitry comprising a plurality of processing circuits, such as, e.g., any, some or all of the ones mentioned above.

The control arrangement 21 may further comprise a memory unit, wherein the calculation unit may be connected to the memory unit, which may provide the calculation unit with, for example, stored program code and/or stored data which the calculation unit may need to enable it to do calculations. The calculation unit may also be adapted to store partial or final results of calculations in the memory unit. The memory unit may comprise a physical device utilised to store data or programs, i.e., sequences of instructions, on a temporary or permanent basis. According to some embodiments, the memory unit may comprise integrated circuits comprising silicon-based transistors. The memory unit may comprise e.g., a memory card, a flash memory, a USB memory, a hard disc, or another similar volatile or non-volatile storage unit for storing data such as e.g., ROM (Read-Only Memory), PROM (Programmable Read-Only Memory), EPROM (Erasable PROM), EEPROM (Electrically Erasable PROM), etc. in different embodiments.

The control arrangement 21 may be connected to components of the vehicle 2 for receiving and/or sending input and output signals. These input and output signals may comprise waveforms, pulses, or other attributes which the input signal receiving devices can detect as information and which can be converted to signals processable by the control arrangement 21. These signals may then be supplied to the calculation unit. One or more output signal sending devices may be arranged to convert calculation results from the calculation unit to output signals for conveying to other parts of the vehicle's control system and/or the component or components for which the signals are intended. Each of the connections to the respective components of the vehicle 2 for receiving and sending input and output signals may take the form of one or more from among a cable, a data bus, e.g., a CAN (controller area network) bus, a MOST (media orientated systems transport) bus or some other bus configuration, or a wireless connection.

In the embodiments illustrated, the vehicle 2 comprises a control arrangement 21 but might alternatively be implemented wholly or partly in two or more control arrangements or two or more control units. Control systems in modern vehicles generally comprise a communication bus system consisting of one or more communication buses for connecting a number of electronic control units (ECUs), or controllers, to various components on board the vehicle. Such a control system may comprise a large number of control units and taking care of a specific function may be shared between two or more of them. Vehicles of the type here concerned are therefore often provided with significantly more control arrangements than depicted in FIG. 2, as one skilled in the art will surely appreciate.

The computer program product 200 may be provided for instance in the form of a data carrier carrying computer program code for performing at least some of the method steps 105, 110, 120, 122, and 124 according to some embodiments when being loaded into one or more calculation units of the control arrangement 21. The data carrier may be, e.g. a CD ROM disc, as is illustrated in FIG. 4, or a ROM (read-only memory), a PROM (programable read-only memory), an EPROM (erasable PROM), a flash memory, an EEPROM (electrically erasable PROM), a hard disc, a memory stick, an optical storage device, a magnetic storage device or any other appropriate medium such as a disk or tape that may hold machine readable data in a non-transitory manner. The computer program product may furthermore be provided as computer program code on a server and may be downloaded to the control arrangement 21 remotely, e.g., over an Internet or an intranet connection, or via other wired or wireless communication systems.

The method 100, as referred to herein, may also be referred to as a method 100 of controlling operation of at least one power source m1, m2, m3 of a powertrain P1, P2, P3 of a vehicle 2.

It is to be understood that the foregoing is illustrative of various example embodiments and that the invention is defined only by the appended independent claims. A person skilled in the art will realize that the example embodiments may be modified, and that different features of the example embodiments may be combined to create embodiments other than those described herein, without departing from the scope of the present invention, as defined by the appended independent claims.

As used herein, the term “comprising” or “comprises” is open-ended, and includes one or more stated features, elements, steps, components, or functions but does not preclude the presence or addition of one or more other features, elements, steps, components, functions, or groups thereof.

It is to be understood that the foregoing is illustrative of various example embodiments and that the invention is defined only by the appended independent claims. A person skilled in the art will realize that the example embodiments may be modified, and that different features of the example embodiments may be combined to create embodiments other than those described herein, without departing from the scope of the present invention, as defined by the appended independent claims.

As used herein, the term “comprising” or “comprises” is open-ended, and includes one or more stated features, elements, steps, components, or functions but does not preclude the presence or addition of one or more other features, elements, steps, components, functions, or groups thereof.

1. A method of controlling operation of a vehicle, wherein the method is performed by a control arrangement and wherein the vehicle comprises two or more powertrains each comprising a power source configured to provide motive power to the vehicle via wheels arranged at a respective wheel axle of the vehicle, wherein each of the two or more powertrains is separate from, and independent of, the other of the two or more powertrains, and
wherein the method comprises:
performing a gear shift in a transmission of one of the two or more powertrains; and
controlling the power source of at least one other powertrain of the two or more powertrains to compensate for at least part of an interruption of a wheel torque obtained during the step of performing the gear shift.

2. The method according to claim 1, wherein the step of controlling the power source comprises:
controlling the power source to increase a positive wheel torque if an interruption of a positive wheel torque is obtained during the step of performing the gear shift.

3. The method according to claim wherein the step of controlling the power source comprises:
controlling the power source to increase a negative wheel torque if an interruption of a negative wheel torque is obtained during the step of performing the gear shift.

4. The method according to claim 1, wherein the method comprises the step of:
blocking gear shifts from being performed in a transmission of at least one other powertrain of the two or more powertrains during the step of performing the gear shift.

5. A computer program product stored on a non-transitory computer-readable medium, said computer program product for controlling operation of a vehicle, wherein the method is performed by a control arrangement, and wherein the vehicle comprises two or more powertrains each comprising a power source configured to provide motive power to the vehicle via wheels arranged at a respective wheel axle of the vehicle, wherein each of the two or more powertrains is separate from, and independent of, the other of the two or more powertrains, and wherein said computer program product comprising computer instructions to cause a control arrangement to perform the following operations:
performing a gear shift in a transmission of one of the two or more powertrains; and
controlling the power source of at least one other powertrain of the two or more powertrains to compensate for at least part of an interruption of a wheel torque obtained during the step of performing the gear shift.

6. (canceled)

7. A control arrangement configured to control operation of a vehicle, wherein the vehicle comprises two or more powertrains each comprising a power source configured to provide motive power to the vehicle via wheels arranged at a respective wheel axle of the vehicle, wherein each of the two or more powertrains is separate from, and independent of, the other of the two or more powertrains, and
wherein the control arrangement is configured to:
perform a gear shift in a transmission of one of the two or more powertrains; and
control the power source of at least one other powertrain of the two or more powertrains to compensate for at least part of an interruption of a wheel torque obtained during the gear shift.

8. A vehicle comprising:
two or more powertrains each comprising a power source configured to provide motive power to the vehicle via wheels arranged at a respective wheel axle of the vehicle wherein each of the two or more powertrains is separate from, and independent of, the other of the two or more powertrains
a control arrangement configured to:
perform a gear shift in a transmission of one of the two or more powertrains; and
control the power source of at least one other powertrain of the two or more powertrains to compensate for at least part of an interruption of a wheel torque obtained during the gear shift.

9. The vehicle according to claim 8, wherein the power source of at least one of the two or more powertrains is an electric machine.

10. The vehicle according to claim 8, wherein the vehicle is a heavy road vehicle, such as a truck or a bus.

11. The computer program product according to claim 5, wherein the step of controlling the power source comprises:
controlling the power source to increase a positive wheel torque if an interruption of a positive wheel torque is obtained during the step of performing the gear shift.

12. The computer program product according to claim 5, wherein the step of controlling the power source comprises:
controlling the power source to increase a negative wheel torque if an interruption of a negative wheel torque is obtained during the step of performing the gear shift.

13. The computer program product according to claim 5, wherein the method comprises the step of:
blocking gear shifts from being performed in a transmission of at least one other powertrain of the two or more powertrains during the step of performing the gear shift.
